(19) United States
(12) Patent Application Publication
(10) Pub. No.: US 2026/0222820 A1
(43) Pub. Date: Jul. 30, 2026

(54) SYSTEM AND METHOD FOR CONTACTLESS DATA TRANSFER AUTHORIZATION VIA GEOTAGGING AND MACHINE LEARNING

(71) Applicant: BANK OF AMERICA CORPORATION, Charlotte, NC (US)

(72) Inventors: Syed Najumudeen, Hyderabad (IN); Gaurav Mukherjee, Thane West (IN); Maharaj Mukherjee, Poughkeepsie, NY (US)

(73) Assignee: BANK OF AMERICA CORPORATION, Charlotte, NC (US)

(21) Appl. No.: 19/037,662

(22) Filed: Jan. 27, 2025

(51) Int. Cl. H04W 12/60; H04W 4/80; H04W 12/06; H04W 12/104; H04W 12/69

(52) U.S. Cl. CPC H04W 12/66; H04W 4/80; H04W 12/06; H04W 12/104; H04W 12/69

(57) ABSTRACT

Systems, computer program products, and methods are described herein for contactless data transfer authorization via geotagging and machine learning. The present disclosure includes receiving a data transfer initiation signal from a terminal device upon an interaction with a contactless reader of the terminal device, capturing geolocation data of the terminal device, determining a preliminary trust category, retrieving details of the terminal device, determining, using a machine learning model, a trust category based on the details of the terminal device, transmitting, upon a first condition where the trust category is untrusted, a first signal to the terminal device, and transmitting, upon a second condition where the trust category is trusted, a second signal to the terminal device.

### TECHNOLOGICAL FIELD

Example implementations of the present disclosure relate to a system and method for contactless data transfer authorization via geotagging and machine learning.

### BACKGROUND

Contactless data transfer technology, using data exchange cards embedded with RFID chips, has revolutionized global data transfers by offering supreme convenience and speed. This technology allows users to execute data transfers by placing the data exchange card near a compatible terminal device without physical contact. Contactless data transfers have experienced widespread adoption across the world. However, the increasing prevalence of contactless data transfers introduces significant and unique challenges regarding malfeasance prevention, including preventing unauthorized access to sensitive data exchange card information by malicious actors using illicit RFID readers or unauthorized terminal devices. These occurrences threaten the security and integrity of the contactless data transfer ecosystem. Thus, there is a need for a system and method for contactless data transfer authorization via geotagging and machine learning.

### BRIEF SUMMARY

Systems, methods, and computer program products are provided for contactless data transfer authorization via geotagging and machine learning.

In one aspect, a system for contactless data transfer authorization via geotagging and machine learning is presented. The system including a processing device, and a non-transitory storage device containing instructions, when executed by the processing device, the instructions cause the processing device to perform the steps of receiving a data transfer initiation signal from a terminal device for a data transfer upon an interaction between a data exchange card and a contactless reader of the terminal device, capturing geolocation data of the terminal device, determining, based on the geolocation data, a preliminary trust category, wherein the preliminary trust category is trusted or untrusted, retrieving details of the terminal device of at least one selected from the group consisting of a terminal device registry, a signal strength of the terminal device, prior data transfers at the terminal device, and an external malfeasance data feed, determining, using a machine learning model, a trust category based on the details of the terminal device, transmitting, upon a first condition where the trust category is untrusted, a first signal to the terminal device selected from the group consisting of at least one of an additional authentication request, a denial of the data transfer, and a disabling of the contactless reader of the terminal device, and transmitting, upon a second condition where the trust category is trusted, a second signal to the terminal device to authorize the data transfer.

In some implementations, the instructions further cause the processing device to, upon the first condition where the trust category is untrusted, perform the steps of receiving extracted credentials data from the data exchange card, and validating at least a portion of the extracted credentials data.

In some implementations, the instructions further cause the processing device to perform the steps of exchanging a secure token, confirming an authenticity of the secure token, retrieving identification data associated with the secure token, the identification data including a reference template, and determining, using the machine learning model, a final trust category by comparing the data transfer to the reference template.

In some implementations, the instructions further cause the processing device to, upon the first or second conditions where the final trust category is trusted or untrusted, perform the steps of updating the reference template of the identification data with the geolocation data and data transfer details including a timestamp, terminal device identifier, and data transfer amount.

In some implementations, the instructions further cause the processing device to perform the steps of retraining the machine learning model using the updated reference template.

In some implementations, the machine learning model determines if the signal strength of the terminal device is an anomalous signal strength based on historical signal strength patterns, and determines if the data transfer is an anomalous data transfer by comparing the data transfer to a historical data transfer pattern of the prior data transfers at the terminal device.

In some implementations, the additional authentication request may include transmitting a prompt for multi-factor authentication.

In another aspect, a computer program product for contactless data transfer authorization via geotagging and machine learning is presented. The computer program product including a non-transitory computer-readable medium including code causing an apparatus to receive a data transfer initiation signal from a terminal device for a data transfer upon an interaction between a data exchange card and a contactless reader of the terminal device, capture geolocation data of the terminal device, determine, based on the geolocation data, a preliminary trust category, wherein the preliminary trust category is trusted or untrusted, retrieve details of the terminal device of at least one selected from the group consisting of a terminal device registry, a signal strength of the terminal device, prior data transfers at the terminal device, and an external malfeasance data feed, determine, using a machine learning model, a trust category based on the details of the terminal device, transmit, upon a first condition where the trust category is untrusted, a first signal to the terminal device selected from the group consisting of at least one of an additional authentication request, a denial of the data transfer, and a disabling of the contactless reader of the terminal device, and transmit, upon a second condition where the trust category is trusted, a second signal to the terminal device to authorize the data transfer.

In some implementations, the code, upon the first condition where the trust category is untrusted, further causes the apparatus to receive extracted credentials data from the data exchange card, and validate at least a portion of the extracted credentials data.

In some implementations, the code further causes the apparatus to exchange a secure token, confirm an authenticity of the secure token, retrieve identification data associated with the secure token, the identification data including a reference template, and determine, using the machine learning model, a final trust category by comparing the data transfer to the reference template.

In some implementations, the code, upon the first or second conditions where the final trust category is trusted or untrusted, further causes the apparatus to update the reference template of the identification data with the geolocation data and data transfer details including a timestamp, terminal device identifier, and data transfer amount.

In some implementations, the code further causes the apparatus to retrain the machine learning model using the updated reference template.

In some implementations, the machine learning model determines if the signal strength of the terminal device is an anomalous signal strength based on historical signal strength patterns, and determines if the data transfer is an anomalous data transfer by comparing the data transfer to a historical data transfer pattern of the prior data transfers at the terminal device.

In some implementations, the additional authentication request may include transmitting a prompt for multi-factor authentication.

In yet another aspect, a method for contactless data transfer authorization via geotagging and machine learning is presented. The method including receiving a data transfer initiation signal from a terminal device for a data transfer upon an interaction between a data exchange card and a contactless reader of the terminal device, capturing geolocation data of the terminal device, determining, based on the geolocation data, a preliminary trust category, wherein the preliminary trust category is trusted or untrusted, retrieving details of the terminal device of at least one selected from the group consisting of a terminal device registry, a signal strength of the terminal device, prior data transfers at the terminal device, and an external malfeasance data feed, determining, using a machine learning model, a trust category based on the details of the terminal device, transmitting, upon a first condition where the trust category is untrusted, a first signal to the terminal device selected from the group consisting of at least one of an additional authentication request, a denial of the data transfer, and a disabling of the contactless reader of the terminal device, and transmitting, upon a second condition where the trust category is trusted, a second signal to the terminal device to authorize the data transfer.

In some implementations, upon the first condition where the trust category is untrusted, the method further may include receiving extracted credentials data from the data exchange card, and validating at least a portion of the extracted credentials data.

In some implementations, the method further may include exchanging a secure token, confirming an authenticity of the secure token, retrieving identification data associated with the secure token, the identification data including a reference template, and determining, using the machine learning model, a final trust category by comparing the data transfer to the reference template.

In some implementations, upon the first or second conditions where the final trust category is trusted or untrusted, the method further may include updating the reference template of the identification data with the geolocation data and data transfer details including a timestamp, terminal device identifier, and data transfer amount.

In some implementations, the method further may include retraining the machine learning model using the updated reference template.

In some implementations, the machine learning model determines if the signal strength of the terminal device is an anomalous signal strength based on historical signal strength patterns, and determines if the data transfer is an anomalous data transfer by comparing the data transfer to a historical data transfer pattern of the prior data transfers at the terminal device.

The above summary is provided merely for purposes of summarizing some example implementations to provide a basic understanding of some aspects of the present disclosure. Accordingly, it will be appreciated that the above-described implementations are merely examples and should not be construed to narrow the scope or spirit of the disclosure in any way. It will be appreciated that the scope of the present disclosure encompasses many potential implementations in addition to those here summarized, some of which will be further described below.

### BRIEF DESCRIPTION OF THE DRAWINGS

Having thus described implementations of the disclosure in general terms, reference will now be made the accompanying drawings. The components illustrated in the Figures may or may not be present in certain implementations described herein. Some implementations may include fewer (or more) components than those shown in the Figures.

FIGS. 1A-1C illustrate technical components of an exemplary distributed computing environment for contactless data transfer authorization via geotagging and machine learning, in accordance with implementations of the disclosure;

FIG. 2 illustrates an exemplary machine learning model subsystem architecture, in accordance with implementations of the disclosure; and

FIG. 3 illustrates a process flow for contactless data transfer authorization via geotagging and machine learning, in accordance with implementations of the disclosure.

### DETAILED DESCRIPTION

Implementations of the present disclosure will now be described more fully hereinafter with reference to the accompanying drawings, in which some, but not all, implementations of the disclosure are shown. Indeed, the disclosure may be implemented in many different forms and should not be construed as limited to the implementations set forth herein; rather, these implementations are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” may be also used herein. Furthermore, when it may be said herein that something may be “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the entity, its products or applications, the customers or any other aspect of the operations of the entity. As such, the entity may be any institution, group, association, financial institution, establishment, company, union, authority or the like, employing information technology resources for processing large amounts of data.

As described herein, a “user” may be an individual associated with an entity. As such, in some implementations, the user may be an individual having past relationships, current relationships or potential future relationships with an entity. In some implementations, the user may be an employee (e.g., an associate, a project manager, an IT specialist, a manager, an administrator, an internal operations analyst, or the like) of the entity or enterprises affiliated with the entity.

As used herein, a “user interface” or “display” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of a computer program, or part of a computer program that serves as a foundation for a larger piece of software and drives the functionality of the software. The term “engine” may be used herein interchangeably with “module” or “model”. An engine may be self-contained, but externally controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some implementations, an engine may be configured to retrieve resources created in other computer programs, which may then be ported into the engine for use during specific operational aspects of the engine. An engine may be configurable to be implemented within any general-purpose computing system. In doing so, the engine may be configured to execute source code embedded therein to control specific features of the general-purpose computing system to execute specific computing operations, thereby transforming the general-purpose system into a specific purpose computing system. In some implementations, an engine may implement a machine learning model or generative AI model to perform functions as a foundation for the larger piece of software that drives the functionality of the software. The machine learning model or generative AI model for any given engine may be self-contained (e.g., without interaction with other engines), or the machine learning model or generative AI model may be shared across one or more engines. In other words, some implementations of the larger piece of software many implement multiple machine learning models or generative AI models to perform functions of the various engines. In other implementations, a single machine learning model or generative AI model may be shared across one or more engines to perform the functions attributed thereto as described herein.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

It should be understood that the word “exemplary” may be used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that an element matches a predetermined criterion, including that a threshold has been met, passed, exceeded, and so on.

Despite the advantages of contactless data transfer technology, the lack of robust mechanisms to prevent unauthorized access to contactless data exchange card information poses a critical security challenge. For example, malicious actors in close proximity to a cardholder may use illicit RFID readers or unauthorized terminal devices to extract sensitive data exchange card details without the cardholder's knowledge or consent. This unauthorized extraction can occur in seconds, leading to malfeasant data transfers and compromising the user's data security. The technical problem thus involves ensuring secure contactless data transfers by mitigating the likelihood of unauthorized access and malfeasant use of contactless data exchange card data.

Existing solutions, such as RFID-blocking wallets, aim to shield data exchange cards from unauthorized access by encasing them in materials designed to block RFID signals. While these wallets provide a partial safeguard, they fail to address the root of the problem, as they require users to adopt and consistently use additional physical accessories. Moreover, reliance on such external tools undermines the convenience that contactless data transfer technology is intended to provide. As a result, there remains an unmet need for an integrated, zone-based approach to securing contactless data transfers that reduces dependency on external protective measures while ensuring robust protection against unauthorized data extraction.

The existing contactless data transfer systems lack an inherent mechanism to dynamically regulate and secure the data transferal environment based on proximity or context, leaving them vulnerable to unauthorized access by malicious actors. The reliance on external protective measures, such as RFID-blocking wallets, highlights a significant technical gap: the absence of an integrated, zone-based security system that can actively detect and prevent unauthorized data extraction attempts in real-time. This deficiency has persisted despite the exponential growth in contactless data transfer adoption, thus exposing countless users to potential malfeasance. The lack of a built-in, seamless solution that addresses these vulnerabilities without compromising the convenience of contactless technology has created a long-felt need for a more robust and user-friendly approach to securing data transfers, which remains unmet by current industry practices.

Addressing these challenges requires the establishment of a system and method for contactless data transfer authorization via geotagging and machine learning, which provides for the implementation of an adaptive approach to ensure secure and efficient data transfers. The system is designed to assess the trustworthiness of data transfer environments dynamically by leveraging contextual and historical data to mitigate unauthorized or malfeasant activities.

To do so, the system may authorize contactless data transfers by leveraging geotagging, machine learning, and secure token exchange. Upon receiving a data transfer initiation signal from a terminal device interacting with a data exchange card, the system may capture the terminal device geolocation data and determine a preliminary trust category as either trusted or untrusted. It may retrieve terminal-specific details, such as its registry status, signal strength, prior data transfer patterns, and external malfeasance data feeds. Using this information, a machine learning model analyzes the data of the terminal-specific details and assigns a trust category. The machine learning model may evaluate anomalies in the terminal device's signal strength and data transfer patterns by comparing them to historical patterns. When additional authentication is required, the system may prompt multi-factor authentication to further secure the contactless data transfers. If the zone is untrusted, the system may transmit a signal to the terminal device to either request additional authentication, deny the data transfer, or disable the contactless reader. If the zone is trusted, the system may authorize the data transfer.

For untrusted zones (and/or trusted zones, in some implementations), the system may validate credentials extracted from the data exchange card and may exchange a secure token. It may confirm the authenticity of the token, retrieve identification data linked to the token, and compare the data transfer to a reference template associated with the user using the machine learning model to determine a final trust category. Based on this determination, the system may either authorize or deny the transfer and update the reference template with geolocation details, including a timestamp, terminal identifier, and transfer amount. The system may further retrain the machine learning model using the updated historical data to refine future geolocation trust assessments.

What is more, the present disclosure provides a technical solution to a technical problem. As described herein, the technical problem includes the inability to dynamically and accurately evaluate the trustworthiness of a data transfer environment in real-time, particularly when relying on conventional methods that fail to adapt to evolving threats, varying geolocations, and terminal device inconsistencies. The present disclosure embraces an improvement over existing solutions by providing a system and method that dynamically evaluates and categorizes data transfer environments in real-time (i) with fewer steps to achieve the solution (e.g., dynamically determining geolocation trust categories without requiring redundant validations), thus reducing the amount of network resources, such as processing resources, storage resources, network resources, and/or the like, that are being used, (ii) providing a more accurate solution to problem, thus reducing the number of resources required to remedy any errors made due to a less accurate solution (e.g., leveraging machine learning models trained on comprehensive datasets, including historical user data, peer data, and external malfeasance feeds, to minimize false positives and false negatives), (iii) removing manual input and waste from the implementation of the solution, thus improving speed and efficiency of the process and conserving network resources (e.g., automating the evaluation of data transfer trustworthiness, reducing dependency on user-provided authentication in trusted zones), (iv) determining an optimal amount of resources that need to be used to implement the solution, thus reducing network traffic and load on existing network resources (e.g., using lightweight secure token exchanges and focused data retrieval only when operating in untrusted zones). In other words, the solution may bypass a series of steps previously implemented, thus further conserving network resources. Furthermore, the technical solution described herein uses a rigorous, computerized process to perform specific tasks and/or activities that were not previously performed.

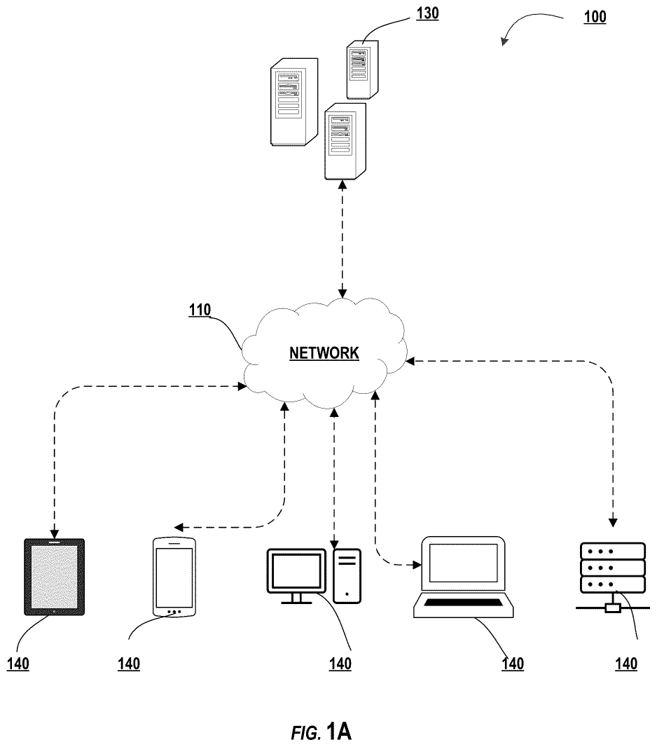

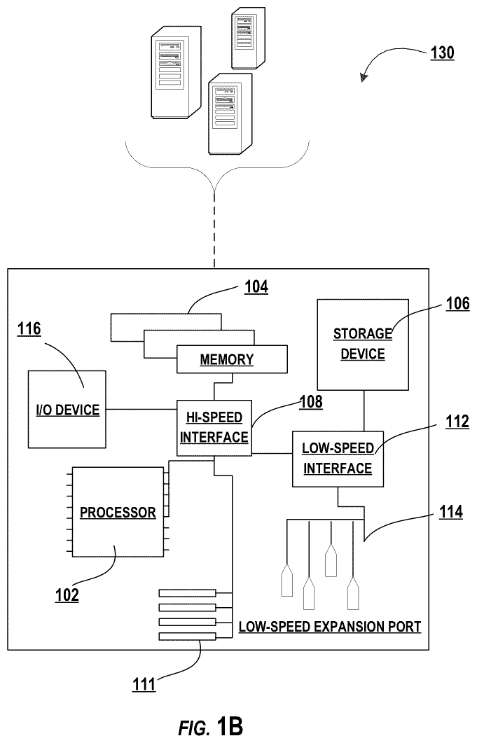

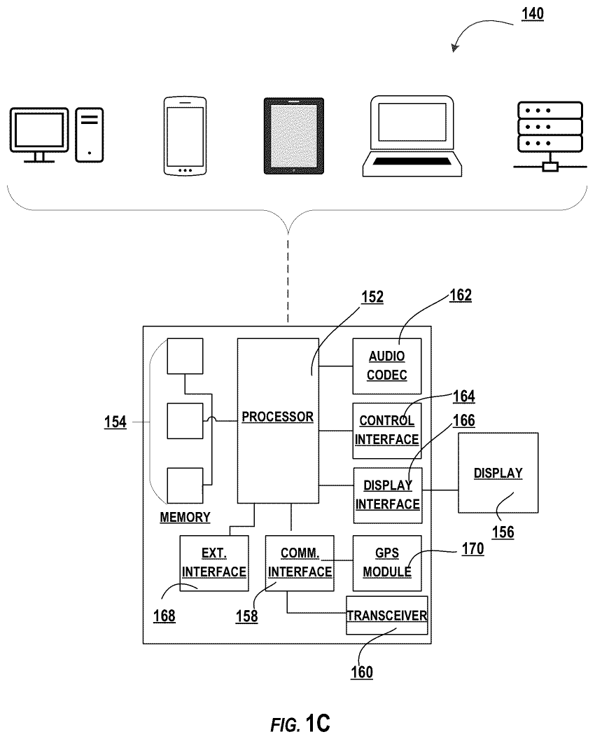

FIGS. 1A-1C illustrate technical components of an exemplary distributed computing environment 100 for contactless data transfer authorization via geotagging and machine learning, in accordance with an implementation of the disclosure. As shown in FIG. 1A, the distributed computing environment 100 contemplated herein may include a system 130, an endpoint device(s) 140, and a network 110 over which the system 130 and endpoint device(s) 140 communicate therebetween. FIG. 1A illustrates only one example of an implementation of the distributed computing environment 100, and it will be appreciated that in other implementations one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some implementations, the system 130 and the endpoint device(s) 140 may have a client-server relationship in which the endpoint device(s) 140 are remote devices that request and receive application from a centralized server, i.e., the system 130. In some other implementations, the system 130 and the endpoint device(s) 140 may have a peer-to-peer relationship in which the system 130 and the endpoint device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The endpoint device(s) 140 may represent various forms of electronic devices, including user input devices such as personal digital assistants, cellular telephones, smartphones, laptops, desktops, and/or the like, input devices such as resource transfer terminals, electronic resource transfer units, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. In addition to shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an implementation of the disclosure. As shown in FIG. 1B, the system 130 may include a processing device 102, memory 104, input/output (I/O) device 116, and a storage device 106. The system 130 may also include a high-speed interface 108 connecting to the memory 104, and a low-speed interface 112 connecting to a low-speed bus 114 and a storage device 106. Each of the components 102, 104, 108, 110, and 112 may be operatively coupled to one another using various buses and may be mounted on a common motherboard or in other manners as appropriate. As described herein, the processing device 102 may include a number of subsystems to execute the portions of processes described herein. Each subsystem may be a self-contained component of a larger system (e.g., system 130) and capable of being configured to execute specialized processes as part of the larger system.

The processing device 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processing devices, along with multiple memories, and/or I/O devices, to execute the processes described herein. In other words, as used herein, a “processing device” means one processing device (e.g., a microprocessor) that performs the defined functions or a plurality of processing devices (e.g., microprocessors) that collectively perform defined functions such that the execution of the individual defined functions may be divided amongst such processing devices.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly implemented in an information carrier. The computer program product may also contain instructions that, when executed, perform one or more methods, such as those described above. The information carrier may be a non-transitory computer-or machine-readable storage medium, such as the memory 104, the storage device 106, or memory on processing device 102.

The high-speed interface 108 manages bandwidth-intensive operations for the system 130, while the low-speed controller 112 manages lower bandwidth-intensive operations. Such allocation of functions is exemplary only. In some implementations, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the endpoint device(s) 140, in accordance with an implementation of the disclosure. As shown in FIG. 1C, the endpoint device(s) 140 includes a processing device 152, memory 154, an input/output device such as a display 156, a communication interface 158, and a transceiver 160, among other components. The endpoint device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processing device 152 is configured to execute instructions within the endpoint device(s) 140, including instructions stored in the memory 154, which in one implementation includes the instructions of an application that may perform the functions disclosed herein, including certain logic, data processing, and data storing functions. The processing device may be implemented as a chipset of chips that include separate and multiple analog and digital processors. The processing device may be configured to provide, for example, for coordination of the other components of the endpoint device(s) 140, such as control of user interfaces, applications run by endpoint device(s) 140, and wireless communication by endpoint device(s) 140.

The processing device 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processing device 152. In addition, an external interface 168 may be provided in communication with processing device 152, so as to enable near area communication of endpoint device(s) 140 with other devices. External interface 168 may provide, for example, for wired communication in some implementations, or for wireless communication in other implementations, and multiple interfaces may also be used.

The memory 154 stores information within the endpoint device(s) 140. The memory 154 can be implemented as one or more of a computer-readable medium or media, a volatile memory unit or units, or a non-volatile memory unit or units. Expansion memory may also be provided and connected to endpoint device(s) 140 through an expansion interface (not shown), which may include, for example, a SIMM (Single In Line Memory Module) card interface. Such expansion memory may provide extra storage space for endpoint device(s) 140 or may also store applications or other information therein. In some implementations, expansion memory may include instructions to carry out or supplement the processes described above and may include secure information also. For example, expansion memory may be provided as a security module for endpoint device(s) 140 and may be programmed with instructions that permit secure use of endpoint device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly implemented in an information carrier. The computer program product contains instructions that, when executed, perform one or more methods, such as those described herein. The information carrier is a computer-or machine-readable medium, such as the memory 154, expansion memory, memory on processing device 152, or a propagated signal that may be received, for example, over transceiver 160 or external interface 168.

In some implementations, the user may use the endpoint device(s) 140 to transmit and/or receive information or commands to and from the system 130 via the network 110. Any communication between the system 130 and the endpoint device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the endpoint device(s) 140 may provide the system 130 (or other client devices) permissioned access to the protected resources of the endpoint device(s) 140, which may include a GPS device, an image capturing component (e.g., camera), a microphone, and/or a speaker.

The endpoint device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to endpoint device(s) 140, which may be used as appropriate by applications running thereon, and in some implementations, one or more applications operating on the system 130.

The endpoint device(s) 140 may also communicate audibly using audio codec 162, which may receive spoken information from a user and convert the spoken information to usable digital information. Audio codec 162 may likewise generate audible sound for a user, such as through a speaker, e.g., in a handset of endpoint device(s) 140. Such sound may include sound from voice telephone calls, may include recorded sound (e.g., voice messages, music files, etc.) and may also include sound generated by one or more applications operating on the endpoint device(s) 140, and in some implementations, one or more applications operating on the system 130.

Various implementations of the distributed computing environment 100, including the system 130 and endpoint device(s) 140, and techniques described here can be realized in digital electronic circuitry, integrated circuitry, specially designed ASICs (application specific integrated circuits), computer hardware, firmware, software, and/or combinations thereof.

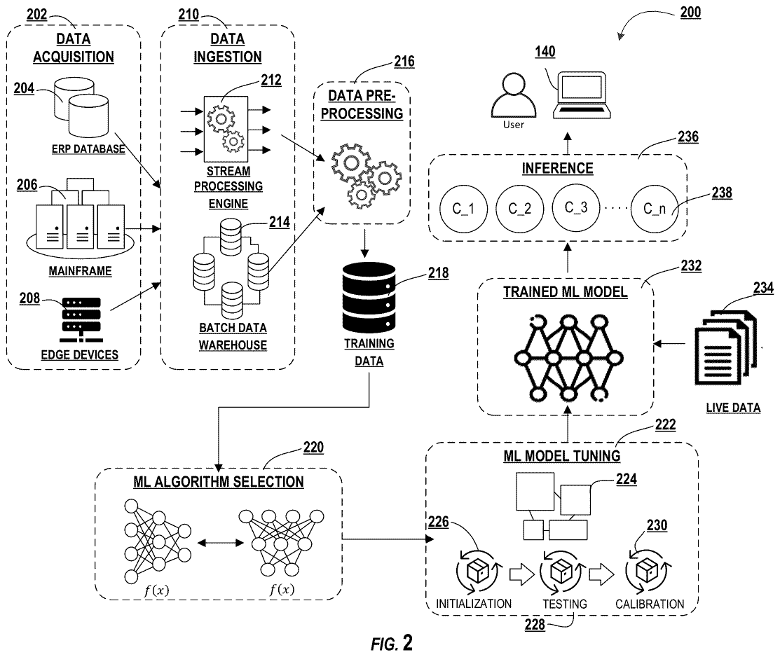

FIG. 2 illustrates an exemplary machine learning model subsystem architecture 200, in accordance with an implementation of the disclosure. The machine learning subsystem 200 may include a data acquisition engine 202, data ingestion engine 210, data pre-processing engine 316, machine learning model tuning engine 222, and inference engine 236.

The data acquisition engine 202 may identify various internal and/or external data sources to generate, test, and/or integrate new features for training the machine learning model. These internal and/or external data sources 204, 206, and 208 may be initial locations where the data originates or where physical information is first digitized. The data acquisition engine 202 may identify the location of the data and describe connection characteristics for access and retrieval of data. In some implementations, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other applications. In some implementations, the these data sources 204, 206, and 208 may include Enterprise Resource Planning (ERP) databases or protocol databases that host data related to day-to-day enterprise activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of network resources to process. Feature extraction and/or selection may be used to select and /r combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points. As will be understood in view of the present disclosure, training data 218 may additionally, or alternatively, be provided from a third party, having been generated as synthetic data.

The machine learning model tuning engine 222 may be used to train a machine learning model to form a trained machine learning model 232 using the training data 218 to make predictions or decisions without explicitly being programmed to do so. The machine learning model 232 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms can adjust their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the machine learning model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the machine learning model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical enterprise decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It shall be understood that the implementation of the machine learning subsystem 200 illustrated in FIG. 2 is exemplary and that other implementations may vary. As another example, in some implementations, the machine learning subsystem 200 may include more, fewer, or different components.

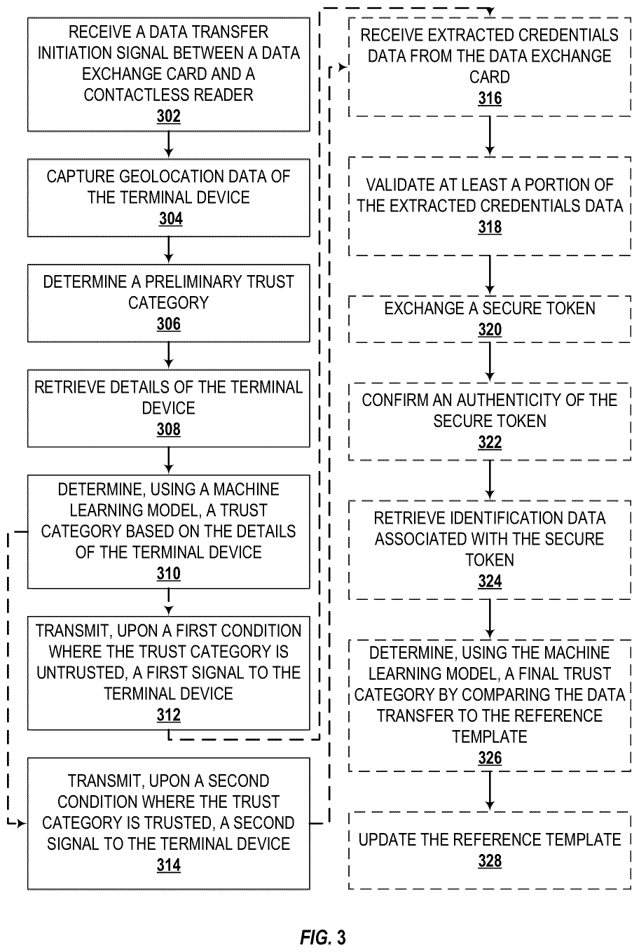

FIG. 3 illustrates a process flow for contactless data transfer authorization via geotagging and machine learning, in accordance with an implementation of the disclosure. The process may begin at block 302 where the system receives a data transfer initiation signal from a terminal device for a data transfer. The data transfer initiation signal may be generated upon an interaction between a data exchange card (i.e., a credit card, debit card, mobile device, endpoint device, or any similar device capable of communicating via NFC, RFID, or the like) and a contactless reader of the terminal device. Upon detecting the data exchange card within the readable range of the contactless reader, the contactless reader of the terminal device may generate a communication link using near-field communication, RFID, or other suitable protocol to establish a channel for data exchange.

The data exchange card may respond to the initial signal from the contactless reader by transmitting a unique identifier and other pertinent data stored in its memory. In some implementations, the transmission may be facilitated by passive components of the data exchange card, which use an electromagnetic field generated by the contactless reader.

At block 304, the system may capture geolocation data of the terminal device. This geolocation data may be determined using one or more different methods. For example, one implementation may use a Global Positioning System (GPS) module of the terminal device to retrieve latitude and longitude coordinates.

Additionally, or alternatively, the system may determine geolocation using Wi-Fi positioning. This method may involve identifying nearby Wi-Fi access points and cross-referencing their MAC addresses or signal strength with a database to approximate the terminal device's location.

Additionally, or alternatively, cellular network triangulation may be implemented, where the location of the terminal device is estimated based on signal measurements from nearby cell towers.

Additionally, or alternatively, the geolocation data may be derived from proximity to known Bluetooth beacons or radio-frequency identification (RFID) tags. These beacons and tags broadcast unique identifiers or signals that are recognized by the terminal device when within range. The device may calculate its location by analyzing the signal strength, time of flight, or other characteristics of the received signals in relation to the known positions of the beacons or tags.

The system may combine multiple geolocation methods to improve accuracy. For example, GPS data may be augmented with Wi-Fi or cellular signals to provide geolocation data in areas with mixed signal availability.

Next, at block 306, the system may determine, based on the geolocation data, a preliminary trust category. It shall be appreciated that certain geographic areas may be more prone to malfeasant activity than others. Similarly, there may be certain areas where data transfers are unlikely to occur. Thus, if a data transfer were to occur in such areas, heightened scrutiny may be warranted.

Thus, based on the geolocation data, the preliminary trust category may be determined to be “trusted” or “untrusted.” To do so, the system may reference a predefined geographic trust map, which associates specific geographic areas with trust categorizations. This map may be stored in a database and may be periodically updated to reflect evolving malfeasance assessments, such as newly identified malfeasance hotspots or areas needing more oversight.

The geolocation data obtained in block 304 may be cross-referenced against the geographic trust map. If the terminal device location is within a geographic area categorized as trusted, the system may preliminarily assign the data transfer as “trusted.” Trusted areas may include known, established merchant locations, regions with historically low malfeasance activity, or areas explicitly determined by the system administrator.

Conversely, if the terminal device geolocation is within a geographic area categorized as “untrusted,” the system may preliminarily assign the data transfer as “untrusted.” Untrusted areas may include regions flagged for frequent malfeasant activity, zones identified through external malfeasance data feeds, or locations outside predefined operational boundaries. These areas may require additional scrutiny, such as with the processes disclosed in detail herein.

In some implementations, the geographic trust map may include multiple layers of data to refine preliminary trust category determinations. For example, areas may be categorized as “trusted” or “untrusted” based on granular details, such as individual store locations versus general city or regional-level categorizations. Additionally, or alternatively, dynamic data, such as recent malfeasance reports (e.g., via malfeasance data feeds) or time-specific trends, may influence the trust map in real-time such as by temporarily or permanently changing areas of the geographic trust map to be “untrusted” based on ongoing current events identified in the mal

Continuing at block 308, the system may retrieve details of the terminal device. In some implementations, details of the terminal device may be retrieved that can be compared to the existence of the terminal device on a terminal device registry. In some implementations, the details retrieved may include a unique terminal identifier, such as a MAC address, serial number, or a public key associated with the terminal device. These details may then be compared to a terminal device registry, which serves as a database of known and trusted terminal devices. The registry may store identifiers of terminal devices that have undergone prior authentication, have been approved by the system administrator, or are associated with specific merchants or geographic locations. By cross-referencing the retrieved details against this registry, the system can determine whether the terminal device is recognized and authorized for use in processing data transfers. A mismatch or absence of the terminal device from the registry may trigger further validation steps described herein.

Additionally, or alternatively, a signal strength of the terminal device may be retrieved. A terminal device signal strength may be determined for one or more of the wireless communication protocols used by the terminal device, such as Wi-Fi, cellular, Bluetooth, or the like, and may serve as a parameter to evaluate the trust category of the terminal device.

For example, the system may compare the observed signal strength against expected ranges based on the device's reported geolocation to identify a discrepancy. In instances where the signal strength is inconsistent with the device's reported position or shows abnormal variations, the system may consider these anomalies as potential indicators of malfeasance (e.g., tampering, unauthorized relocation, the use of a spoofing device, or the like).

Additionally, or alternatively, an external malfeasance data feed may be retrieved. The external malfeasance data feed may include data sourced from industry consortiums, cybersecurity firms, malfeasance intelligence providers that track malfeasance trends, malicious activities, and emerging threat vectors, or the like. Examples of such external malfeasance data feeds include reports on compromised terminal devices, patterns of malfeasant data transfers, techniques used in recent malfeasance, and so forth. The external malfeasance data feed may be provided as an RSS feed, webhook, JSON feed, API, or the like. The system may incorporate one or more external malfeasance data feeds to dynamically assess the terminal device trust category. For example, if the external malfeasance data feed indicates that terminal devices of a specific make or model are frequently associated with malfeasance, data transfers involving such devices may warrant additional scrutiny. Similarly, real-time alerts about regional malfeasance trends may prompt the system to adjust its anomaly thresholds or initiate enhanced validation protocols for terminal devices operating within affected areas.

Natural language processing (NLP) techniques may be utilized to analyze the external malfeasance data feeds and extract relevant insights for the dynamic system adjustments. By parsing textual reports, structured data, and alerts contained within the feeds, the system can identify patterns, keywords, and contextual relationships indicative of emerging malfeasance trends. For instance, NLP algorithms may detect specific phrases or references to vulnerabilities, new techniques, or regions experiencing increased malfeasance activity.

Additionally, or alternatively, prior data transfer patterns may be retrieved for the terminal device, including data transfers in the past that have occurred at the terminal device, the times at which they occur, or the like.

At block 310, the system may determine, using a machine learning model, a trust category based on the details of the terminal device retrieved at block 308. The machine learning model may identify anomalies by analyzing the terminal device details in conjunction with historical patterns, predefined rules, contextual data, and so forth. The machine learning model may extract features such as the terminal device identifier, firmware version, geographic location, signal strength, and so forth, and compare these against expected values or patterns established from trusted terminal devices. In some implementations, techniques such as clustering or outlier detection, may be used by the machine learning model to flag deviations. For example, if a terminal device exhibits behavior inconsistent with its historical operation, such as unexpected changes in firmware or location mismatches, the machine learning model may flag these as potential anomalies. The anomalies may then be prepared for further evaluation against predetermined thresholds to determine their severity and implications for the trust category.

Once the machine learning model identifies the presence of an anomaly, the anomaly may be evaluated against a predetermined threshold. If the anomaly satisfies the threshold condition, it may be assigned one of the trust categories of “untrusted” or “trusted.” Comparison of the anomaly to the predetermined threshold may include extracting relevant features or characteristics of the anomaly. In some implementations, data transfers in the “trusted” or “untrusted” trust categories may be logged along with the anomaly detected, for example in some implementations to raise or lower the predetermined threshold.

To determine whether the signal strength of the terminal device is an anomalous signal strength, the machine learning model may analyze the current signal strength value against historical signal strength patterns for that specific terminal device and its typical operating environment. The machine learning model may extract features such as average signal strength, variance, and fluctuations over time, and use one or more of these to create a baseline for the terminal device. If the current signal strength deviates significantly from this baseline, such as exhibiting abnormally high attenuation or unexpected spikes, the anomaly may be evaluated against a predetermined threshold. For example, a data transfer with a signal strength anomaly above the predetermined threshold may be assigned to the “untrusted” trust category. Conversely, minor deviations that fall within acceptable operating ranges may result in the data transfer being assigned to the “trusted” trust category.

To compare the external malfeasance data feed, the system may evaluate the anomaly against patterns or trends flagged in the external malfeasance data feed. For example, if the external malfeasance data feed indicates that a particular terminal device model has been targeted in recent malfeasance, the machine learning model may prioritize anomalies involving terminal devices of that model. The system may compare the geographic location, device identifier, or associated data transfer behavior to the flagged patterns. If there is a strong correlation to the external malfeasance data feed, the data transfer may be assigned to the “untrusted” group.

To determine if a data transfer is an anomalous data transfer (e.g., based on prior data transfer patterns), the system may analyze the data transfer characteristics, such as transfer size, speed, frequency, and timing, against a historical data transfer pattern for the terminal device. For example, if the terminal device typically processes small data transfers during daytime hours but a data transfer involves a significantly larger payload at an unusual time, the machine learning model may flag this as an anomaly. Features of the anomaly, such as deviation from normal payload size or time of day, are evaluated against a numerical or probabilistic threshold. If the deviation exceeds the threshold, the data transfer may be categorized as “untrusted,” indicating a possible unauthorized or malfeasant transfer.

In some implementations, one or more of the factors described above, including signal strength deviations, external malfeasance data correlations, or anomalous data transfer characteristics, may be weighted using predetermined weights to determine whether a data transfer is categorized as “trusted” or “untrusted.” These weights may be applied to features extracted from the anomaly to calculate a composite trust score or probability, which is then compared to the predetermined threshold. By adjusting the weights assigned to various factors, the system can fine-tune its evaluation criteria to enhance its accuracy and adaptability in different operational contexts.

Next, at block 312, the system may transmit, upon a first condition where the trust category is untrusted, a first signal to the terminal device.

For example, in some implementations, the system may transmit a first signal resulting in an additional authentication request. This additional authentication request may include a request for fingerprint recognition, facial recognition, voice analysis, retina scanning, or the like. Additionally, or alternatively, the additional authentication request may include knowledge-based methods, such as providing a password, answering security questions, or entering a pre-determined PIN code. The authentication request may also utilize device-based mechanisms, including verifying possession of a hardware token, a secure access card, or a cryptographic key stored on a trusted device. Additionally, or alternatively, the system may prompt for data transferal data confirmation, such as entering a code sent via SMS, email, or a push notification, or validating contextual information like location, IP address, or time-based access restrictions. In some implementations, the system may initiate a challenge-response protocol requiring the user to correctly perform a specific task or enter a cryptographic response derived from a private key.

In some implementations, the additional authentication request may include transmitting a prompt for multi-factor authentication. This prompt may direct the user to verify their identity through combinations of distinct authentication factors described above. For example, the system may require a password entry in conjunction with a fingerprint scan, face scan, voice analysis, retinal scan, palm scan, or the like scan, such as a fingerprint or facial recognition. The prompt may also request validation through a physical token, such as a smart card or a USB security key, alongside a PIN or a time-sensitive one-time password (OTP) delivered through a secure channel. In other implementations, the system may prompt for both a cryptographic signature generated by a personal device and confirmation of location or device-based contextual data.

Additionally, or alternatively, the first signal may result in the outright denial and stopping of the data transfer altogether. Additionally, or alternatively, the first signal may result in the disabling of the contactless reader of the terminal device to prevent any further action on the present data transfer and/or future data transfers at the terminal device.

Continuing at block 314, the system may transmit, upon a second condition where the trust category is trusted, a second signal to the terminal device to authorize the data transfer. In some implementations, upon receiving the second signal, the terminal device may proceed to complete the data transfer by transmitting the requested data to the intended recipient or processing the data transfer as instructed. In some implementations, the system may monitor the transfer to ensure it adheres to predefined protocols, and verify that the data integrity and security measures, such as encryption, remain intact throughout the process. In such implementations, once the data transfer is successfully completed, the system may log the data transfer details for audit purposes and confirm the successful execution of the transfer to relevant parties.

In other implementations, the data transfer may not yet proceed, and the process steps at block 316 and thereafter may be followed. Indeed, additional validation and secure exchange of a secure token may be beneficial to the entity to provide additional malfeasance prevention. Furthermore, additional steps described hereinafter may result in the improvement of the machine learning model used at block 310 by adjusting predetermined thresholds or the like, to result in better determination of trust categories during future data transfers. As such, in either the first and/or the second conditions (depending on the specific implementation of the disclosure), the process may proceed at block 316, where the system may receive extracted credentials data from the data exchange card.

Credentials data extracted from the data exchange card may be received by the system, such as credentials associated with the account holder's identity, account number, expiration date, security code, or the like. The system may process this data to generate a secure token to represent the credentials data in a format that mitigates the likelihood of exposure during data transfers. The generated token may then be transmitted to an external entity or utilized within the system to validate the data transfer while preserving the security and confidentiality of the original credentials.

At block 318, the system may validate at least a portion of the extracted credentials data. The system may randomly sample specific data fields from the credentials, such as account numbers, personal identification details, digital signatures, or the like, and cross-check these against databases. The system may use checksum algorithms to confirm the structural validity of certain fields, such as account numbers or identification codes, and ensure they conform to expected formats and mathematical rules. For credentials incorporating QR codes or barcodes, the system may scan and decode these elements to retrieve and verify the embedded data. The system may also compare metadata, such as issuance dates, expiration dates, and issuing authority identifiers, against predefined standards or known trustworthy sources.

In some implementations, the process may continue at block 320, where the system exchanges a secure token. The system, in operable communication with the terminal device that received the credentials data, may receive data transfer data, such as the primary account number (PAN) and associated data transfer details. Upon receipt, the system may transmit the resource transfer data to be tokenized to generate a secure token.

The tokenization may replace the data transfer data with a unique token that maintains the necessary structure and format for data transfer processing but lacks the capacity to expose the original underlying data. The system may then associate the secure token with the specific data transfer.

The system may transmit the secure token, along with any relevant data transfer metadata (e.g., data transfer amount, merchant identifier, and/or timestamp), for authorization, either at a third-party entity or within the same entity system. The secure token may be de-tokenized to validate the data transfer.

Once the data transfer is authorized or declined, the system may then transmit this response to the terminal device, enabling the device to inform the user of the data transfer status. In some implementations, the system may also store the secure token within a secure storage environment to support subsequent operations, such as refunds or recurring billing, without necessitating re-entry of credentials.

At block 322, the system may confirm an authenticity of the secure token. This confirmation may involve validating the secure token against a token registry or a cryptographic signature embedded within the token itself. The token registry may store metadata associated with each issued secure token, such as its creation timestamp, associated PAN, expiration details, or the like. In some implementations, the system may also verify the secure token by using cryptographic techniques, such as checking a digital signature or hash value embedded in the token.

The process may continue at block 324, where the system retrieves identification data associated with the secure token, the identification data including a reference template.

As used herein, a “reference template” may refer to a predefined data construct representing characteristic information associated with a user, including but not limited to fingerprint scan, face scan, voice analysis, retinal scan, palm scan, or the like data, behavioral patterns, geographic data indicative of user location history or preferences, terminal device-specific identifiers, and/or other attributes uniquely identifying the user. The reference template may be used as a basis for comparison to verify the identity of the user or to detect deviations from expected norms.

At block 326, the system may determine, using the machine learning model, a final trust category by comparing the data transfer to the reference template. In some implementations, the machine learning model may perform a comparison of input data from a user (e.g., location of the data transfer, time of the data transfer, credentials supplied to the terminal device during the data transfer, or the like) to the reference template that may include parameters associated with normal user behavior. The machine learning model may then produce a similarity metric by reference to the user's historical data in the reference template and generate a confidence score that indicates whether an action comports with patterns or data stored within the reference template.

If the machine learning model identifies a deviation from a threshold level of similarity (e.g., a predetermined threshold of the similarity metric), the system may indicate the final trust category as being “trusted” or “untrusted”, and either proceed with the data transfer via a second signal similar to block 314 or end the data transfer via a first signal similar to that in block 312.

At block 328, the system may update the reference template of the identification data with the geolocation data and data transfer details. The data transfer details may include a timestamp, terminal device identifier, data transfer amount, geolocation, or any other details associated with the data transfer and/or the terminal device and/or the data transfer card used. This may occur upon either the first or second conditions where the final trust category is trusted or untrusted. The reference template may be updated after each data transfer to account for natural shifts in user behavior. Alternatively, in some implementations, the reference template may only be updated if the final trust category has been determined to be either trusted or non-trusted.

In some implementations, the system may retrain the machine learning model. The retraining process may adjust the machine learning model parameters to improve its accuracy and adaptability in processing subsequent inputs. In some implementations, the machine learning model may be updated using the updated reference template. The system may utilize a dataset that incorporates the updated reference template to fine-tune the model's predictive capabilities. Additionally, or alternatively, the machine learning model may be retrained to change the predetermined thresholds for determining the trust category in block 310. This retraining process may occur periodically, on-demand, or automatically in response to specific triggers. As such, future trust categorization throughout the process described herein may undergo continual improvement over time.

As will be appreciated by one of ordinary skill in the art, the present disclosure may be implemented as an apparatus (including, for example, a system, a machine, a device, a computer program product, and/or the like), as a method (including, for example, an enterprise process, a computer-implemented process, and/or the like), as a computer program product (including firmware, resident software, micro-code, and the like), or as any combination of the foregoing. Many modifications and other implementations of the present disclosure set forth herein will come to mind to one skilled in the art to which these implementations pertain having the benefit of the teachings presented in the foregoing descriptions and the associated drawings. Although the Figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system for contactless data transfer authorization via geotagging and machine learning, the system comprising:
a processing device; and
a non-transitory storage device containing instructions, when executed by the processing device, the instructions cause the processing device to perform the steps of:
receiving a data transfer initiation signal from a terminal device for a data transfer upon an interaction between a data exchange card and a contactless reader of the terminal device;
capturing geolocation data of the terminal device;
determining, based on the geolocation data, a preliminary trust category, wherein the preliminary trust category is trusted or untrusted;
retrieving details of the terminal device of at least one selected from the group consisting of: a terminal device registry, a signal strength of the terminal device, prior data transfers at the terminal device, and an external malfeasance data feed;
determining, using a machine learning model, a trust category based on the details of the terminal device;
transmitting, upon a first condition where the trust category is untrusted, a first signal to the terminal device selected from the group consisting of at least one of: an additional authentication request, a denial of the data transfer, and a disabling of the contactless reader of the terminal device; and
transmitting, upon a second condition where the trust category is trusted, a second signal to the terminal device to authorize the data transfer.

2. The system of claim 1, wherein the instructions further cause the processing device to, upon the first condition where the trust category is untrusted, perform the steps of:
receiving extracted credentials data from the data exchange card; and
validating at least a portion of the extracted credentials data.

3. The system of claim 2, wherein the instructions further cause the processing device to perform the steps of:
exchanging a secure token;
confirming an authenticity of the secure token;
retrieving identification data associated with the secure token, the identification data comprising a reference template; and
determining, using the machine learning model, a final trust category by comparing the data transfer to the reference template.

4. The system of claim 3, wherein the instructions further cause the processing device to, upon the first or second conditions where the final trust category is trusted or untrusted, perform the steps of:
updating the reference template of the identification data with the geolocation data and data transfer details comprising a timestamp, terminal device identifier, and data transfer amount.

5. The system of claim 4, wherein the instructions further cause the processing device to perform the steps of:
retraining the machine learning model using the updated reference template.

6. The system of claim 1, wherein the machine learning model:
determines if the signal strength of the terminal device is an anomalous signal strength based on historical signal strength patterns; and
determines if the data transfer is an anomalous data transfer by comparing the data transfer to a historical data transfer pattern of the prior data transfers at the terminal device.

7. The system of claim 1, wherein the additional authentication request comprises transmitting a prompt for multi-factor authentication.

8. A computer program product for contactless data transfer authorization via geotagging and machine learning, the computer program product comprising a non-transitory computer-readable medium comprising code causing an apparatus to:
receive a data transfer initiation signal from a terminal device for a data transfer upon an interaction between a data exchange card and a contactless reader of the terminal device;
capture geolocation data of the terminal device;
determine, based on the geolocation data, a preliminary trust category, wherein the preliminary trust category is trusted or untrusted;
retrieve details of the terminal device of at least one selected from the group consisting of:
a terminal device registry, a signal strength of the terminal device, prior data transfers at the terminal device, and an external malfeasance data feed;
determine, using a machine learning model, a trust category based on the details of the terminal device;
transmit, upon a first condition where the trust category is untrusted, a first signal to the terminal device selected from the group consisting of at least one of: an additional authentication request, a denial of the data transfer, and a disabling of the contactless reader of the terminal device; and
transmit, upon a second condition where the trust category is trusted, a second signal to the terminal device to authorize the data transfer.

9. The computer program product of claim 8, wherein the code, upon the first condition where the trust category is untrusted, further causes the apparatus to:
receive extracted credentials data from the data exchange card; and
validate at least a portion of the extracted credentials data.

10. The computer program product of claim 9, wherein the code further causes the apparatus to:
exchange a secure token;
confirm an authenticity of the secure token;
retrieve identification data associated with the secure token, the identification data comprising a reference template; and
determine, using the machine learning model, a final trust category by comparing the data transfer to the reference template.

11. The computer program product of claim 10, wherein the code, upon the first or second conditions where the final trust category is trusted or untrusted, further causes the apparatus to:
update the reference template of the identification data with the geolocation data and data transfer details comprising a timestamp, terminal device identifier, and data transfer amount.

12. The computer program product of claim 11, wherein the code further causes the apparatus to:
retrain the machine learning model using the updated reference template.

13. The computer program product of claim 8, wherein the machine learning model:
determines if the signal strength of the terminal device is an anomalous signal strength based on historical signal strength patterns; and
determines if the data transfer is an anomalous data transfer by comparing the data transfer to a historical data transfer pattern of the prior data transfers at the terminal device.

14. The computer program product of claim 8, wherein the additional authentication request comprises transmitting a prompt for multi-factor authentication.

15. A method for contactless data transfer authorization via geotagging and machine learning, the method comprising:
receiving a data transfer initiation signal from a terminal device for a data transfer upon an interaction between a data exchange card and a contactless reader of the terminal device;
capturing geolocation data of the terminal device;
determining, based on the geolocation data, a preliminary trust category, wherein the preliminary trust category is trusted or untrusted;
retrieving details of the terminal device of at least one selected from the group consisting of: a terminal device registry, a signal strength of the terminal device, prior data transfers at the terminal device, and an external malfeasance data feed;
determining, using a machine learning model, a trust category based on the details of the terminal device;
transmitting, upon a first condition where the trust category is untrusted, a first signal to the terminal device selected from the group consisting of at least one of: an additional authentication request, a denial of the data transfer, and a disabling of the contactless reader of the terminal device; and
transmitting, upon a second condition where the trust category is trusted, a second signal to the terminal device to authorize the data transfer.

16. The method of claim 15, wherein, upon the first condition where the trust category is untrusted, the method further comprises:
receiving extracted credentials data from the data exchange card; and
validating at least a portion of the extracted credentials data.

17. The method of claim 16, wherein the method further comprises:
exchanging a secure token;
confirming an authenticity of the secure token;
retrieving identification data associated with the secure token, the identification data comprising a reference template; and
determining, using the machine learning model, a final trust category by comparing the data transfer to the reference template.

18. The method of claim 17, wherein, upon the first or second conditions where the final trust category is trusted or untrusted, the method further comprises:
updating the reference template of the identification data with the geolocation data and data transfer details comprising a timestamp, terminal device identifier, and data transfer amount.

19. The method of claim 18, wherein the method further comprises:
retraining the machine learning model using the updated reference template.

20. The method of claim 15, wherein the machine learning model:
determines if the signal strength of the terminal device is an anomalous signal strength based on historical signal strength patterns; and
determines if the data transfer is an anomalous data transfer by comparing the data transfer to a historical data transfer pattern of the prior data transfers at the terminal device.
